(19) United States
(12) Patent Application Publication
(10) Pub. No.: US 2023/0126707 A1
(43) Pub. Date: Apr. 27, 2023

(54) ELECTRICAL CONNECTION MEANS FOR CONNECTING TERMINALS OF BATTERY UNITS IN BATTERY PACK

(71) Applicant: TECHTRONIC CORDLESS GP, Anderson, SC (US)

(72) Inventors: Hei Man LEE, Dongguan City (CN); Lifeng WANG, Dongguan City (CN); Shengfu YU, Dongguan City (CN); Weipeng CHEN, Dongguan City (CN); Nan WANG, Dongguan City (CN); Zexin CHEN, Dongguan City (CN)

(21) Appl. No.: 18/049,047

(22) Filed: Oct. 24, 2022

(30) Foreign Application Priority Data
Oct. 25, 2021 (CN) 202111240246.2

(51) Int. Cl. H01M 50/507; H01M 50/204; H01M 50/583

(52) U.S. Cl. CPC H01M 50/507; H01M 50/204; H01M 50/583; H01M 2200/103

(57) ABSTRACT

An electrical connector configured to connect terminals of battery units in a battery pack includes a body made of an electrically conductive material, the body having at least a first body part and a second body part, and at least one terminal connection part disposed adjacent the first body part configured to connect to the terminal of the battery unit. The at least one terminal connection part includes a first connection component and a second connection component spaced apart from each other. Each of the first and second connection components includes a contact part for contacting the terminal of the battery unit, and a stem connecting the contact part to the body. The stem has a smaller cross section than the contact part. The stem is operable as a fuse configured to cut off an excessively high current.

### TECHNICAL FIELD

The present invention relates to an electrical connector for connecting terminals of battery units in a battery pack.

### BACKGROUND ART

Electrical connector for connecting terminals of battery units in a battery pack are already known. The electrical connector is generally welded by spot welding to the terminals of the battery units.

### SUMMARY

When currents generated in the spot welding process pass through the various parts of the electrical connector, there might be a chance of blackening or even melt-through at a part or position of the electrical connector or at the periphery thereof. Some electrical connector are provided with a fuse or fusible part for cutting off excessively high currents. Because the fuse or fusible part has a very small cross section, it is quite common for blackening or even melt-through to occur when the fuse or fusible part is undergoing the spot welding process.

One or more embodiments of the present disclosure may eliminate or at least reduce local blackening or even melt-through caused by the high temperatures that occur when an electrical connector is welded. The electrical connector comprises a body made of an electrically conductive material. Each body at least has a first body part and a second body part, and at least one terminal connection part provided by the first body part or the second body part, for connecting to the terminal of the battery unit. The terminal connection part comprises at least one connection component, each connection component comprising a contact part for contacting the terminal of the battery unit. The terminal connection part further comprises at least one stem connecting the contact part to the first body part or the second body part. Multiple bodies are connected to each other by at least one connection part. Each connection part has at least one fusible part, which has a smaller cross section than the stem 8 and is used as a fuse for cutting off an excessively high current.

According to one embodiment, the at least one terminal connection part comprises a first connection component and a second connection component which are two in number and spaced apart, and which are respectively connected to the body via respective said stems.

According to one embodiment, the at least one connection part is provided with a locally narrow part as the at least one fusible part.

According to one embodiment, an opening is provided in the at least one connection part to form the at least one fusible part.

According to one embodiment, the opening is a through-hole.

According to another embodiment of the present invention, an electrical connector for connecting terminals of battery units in a battery pack is provided, comprising a body made of an electrically conductive material, the body at least having a first body part and a second body part; and at least one terminal connection part provided by the first body part or the second body part, for connecting to the terminal of the battery unit. The at least one terminal connection part comprises a first connection component and a second connection component which are at least two in number and spaced apart; and each of the connection components comprises a contact part for contacting the terminal of the battery unit, and a stem connecting the contact part to the body. The stem has a smaller cross section than the contact part, and the stem is used as a fuse for cutting off an excessively high current.

According to one embodiment, the contact parts of the first connection component and the second connection component extend in the same direction, or extend in different directions relative to each other.

According to one embodiment, the contact part of the first connection component is connected to the body by the stem via a strip.

According to one embodiment, the strip has an outwardly projecting first end connected to the body, and the strip has a second end as a far end, which is connected to the stem.

According to one embodiment, the strip extends along a partly circular or approximately semicircular path.

According to one embodiment, the contact parts of the first connection component and the second connection component are arranged adjacent (close) to each other.

According to one embodiment, the contact parts of the first connection component and the second connection component have respective straight edges, which extend together in parallel on two opposite sides of the gap.

According to one embodiment, the contact parts of the first connection component and the second connection component have shapes that are substantially mirror images of each other.

According to one embodiment, the contact parts of the first connection component and the second connection component are configured to form a substantially circular or disk-like combined shape.

According to one embodiment, the angle at which the contact parts of the first connection component and the second connection component extend in different directions relative to each other is 90°-270°.

According to one embodiment, the angle at which the contact parts of the first connection component and the second connection component extend in different directions relative to each other is in the range of 170°-190°.

According to one embodiment, the angles at which the contact parts of the first connection component and the second connection component extend in different directions relative to each other differ by approximately 180°.

According to one embodiment, the respective positions of the stems of the first connection component and the second connection component are radially opposite each other.

According to one embodiment, the electrical connector further comprises two said terminal connection parts; the terminal connection part is provided by the corresponding first body part or second body part, and used for connecting to a corresponding terminal of a battery unit adjacent to said battery unit.

According to one embodiment, the electrical connector further comprises a circuit connection part provided by the first body part or the second body part, for connecting to an operating circuit of the battery pack.

### BRIEF DESCRIPTION OF THE DRAWINGS

FIG. 1 shows a view of an electrical connector according to one or more embodiments of the present invention.

FIG. 2 shows a three-dimensional view based on the electrical connector in FIG. 1.

FIG. 3 shows a partial enlarged drawing of the electrical connector in FIG. 2.

FIGS. 4a-4c show plans of an electrical connector according to one or more embodiments of the present invention.

FIG. 5 shows an elevation based on the electrical connector in FIG. 4.

FIG. 6 shows a plan based on the terminal connection part of the electrical connector in FIG. 4.

FIG. 7 shows a plan of the terminal connection part according to one or more embodiments of the present invention.

FIG. 8 shows a view of an electrical connector according to one or more embodiments of the present invention.

FIG. 9 shows a three-dimensional view based on the electrical connector in FIG. 8.

FIG. 10 shows a view of an electrical connector according to one or more embodiments of the present invention.

FIG. 11 shows a three-dimensional view based on the electrical connector in FIG. 10; and

FIGS. 12a-12d show possible situations after welding of an ordinary electrical connector.

### DETAILED DESCRIPTION OF EMBODIMENTS

Before explaining any embodiment of the present invention in detail, it should be understood that the applications of the present invention are not limited to the structural details and component arrangements expounded in the following description or shown in the drawings. The present invention can have other embodiments and can be implemented or executed in various ways. Similarly, it should be understood that the words and terms used herein are intended to describe, and should not be regarded as limiting. General terms, terms relating to extent, such as “substantially” or “about” are to be understood as indicating a suitable range outside a given value, for example a general tolerance associated with the manufacture, assembly and use of the embodiment described. In addition, the use of “comprises”, “provided with” or “has” and variants thereof herein is intended to encompass the subsequently listed items and their equivalents and additional items.

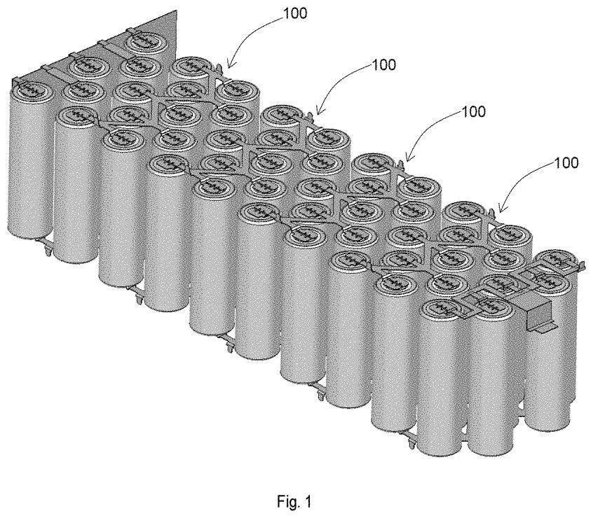

FIGS. 1-11 show electrical connector for connecting terminals of battery units in a battery pack according to embodiments of the present invention. An electrical connector 1 is used to connect multiple battery units in a battery pack, connecting ends of the battery units in series and/or in parallel.

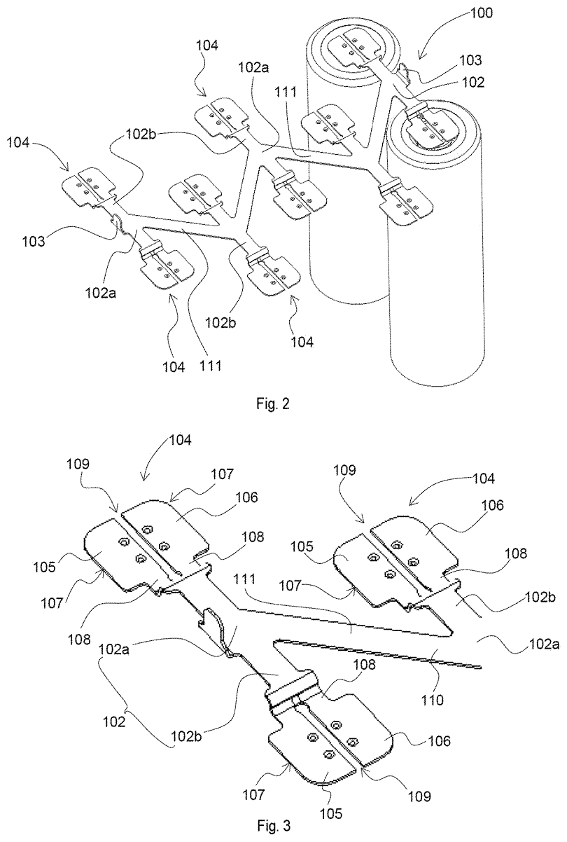

FIGS. 1-3 show an electrical connector 100 according to one or more embodiments of the present invention, used to connect terminals 10 of multiple battery units. Each electrical connector 100 can simultaneously connect ten battery units in a specific arrangement. The electrical connector 100 mainly comprises multiple bodies 102; each body 102 can at least be divided into a first body part 102a and a second body part 102b. The first body part 102a is substantially flat, and is provided with a circuit connection part 103 for connecting to an operating circuit of the battery pack. In general, the circuit connection part 103 may be integrally formed with the first body part 102a of at least one body 102, but may also be connected to the first body part 102a by welding. The circuit connection part 103 is electrically connected by welding to a port (not shown) on a circuit board having the operating circuit. The other part of the body 102 is the second body part 102b, which is connected to the first body part 102. The first body part 102a and second body part 102b are integrally formed. According to one or more embodiments, the electrical connector 100 is made of an elastically deformable electrically conductive material. As shown in FIG. 2, the electrical connector 100 has five bodies 102 arranged in parallel, each body 2 being connected to terminals 10 of two battery units.

As shown in FIGS. 2 and 3, the second body part 102b has at least one terminal connection part 104 for connecting to a battery unit terminal 10. Specifically, the second body part 102b has two terminal connection parts 104; the terminal connection part 104 is provided by the corresponding second body part 102b, and used for connecting to the corresponding terminal 10 of a battery unit adjacent to said battery unit. The shape of the terminal connection part 104 may depend on the shape of the terminal 10 of the battery unit. The area of the terminal connection part 104 should be smaller than that of the terminal 10 of the battery unit.

Each terminal connection part 104 has at least one connection component 105. According to one or more embodiments, each terminal connection part 4 has two connection components, i.e. a first connection component 105 and a second connection component 106. The first connection component 105 and second connection component 106 are arranged individually. The second connection component 106 and the first connection component 105 are located in substantially the same plane, and are configured to adjoin a surface of the terminal 10 of the battery unit or to be biased towards the surface of the terminal 10 of the battery unit. The first connection component 105 and second connection component 106 may be offset towards the terminal of the battery unit in relation to the second body part 102b, in order to weld the terminal connection part 104 to the terminal of the battery unit. The terminal connection part 104 further comprises a stem 108 connecting the contact part 107 to the first body part 102a. The first connection component 105 and second connection component 106 are spaced apart by a certain distance and extend in the same direction. The first connection component 105 and second connection component 106 are respectively connected to the second body part 102b by their respective stems 108. The stem 108 is the only connection path connecting each connection component 105, 106 to the second body part 102b. The stem 108 has a smaller cross section than the contact part 107. As shown in FIG. 3, the stem 108 is narrower than the first and second connection components 105, 106. The stems 108 of the first connection component 105 and second connection component 106 are spaced apart by a certain distance and form a gap 109.

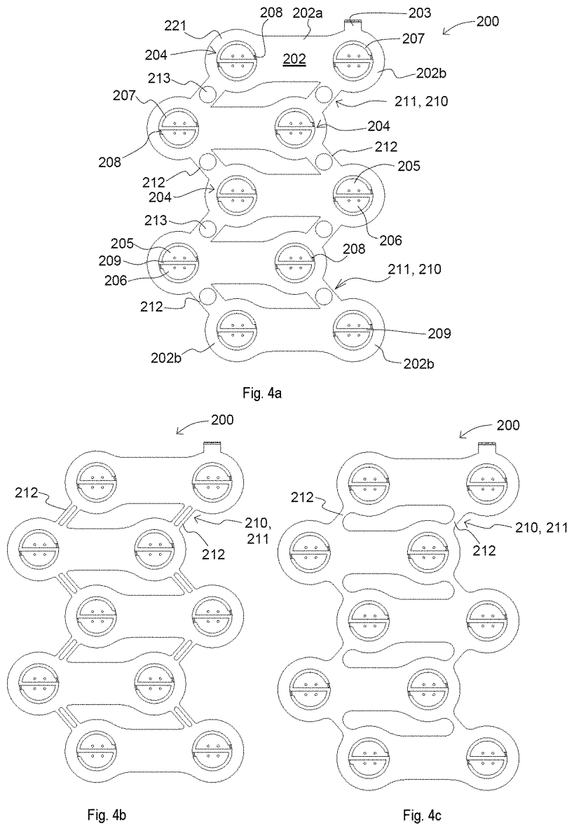

The multiple bodies 102 are connected to each other by at least one connection part 110. As shown in FIG. 2, one body 102 is connected to another body 102 by one connection part 110. FIG. 4 shows one or more embodiments of the present invention, in which one body 102 and another body 102 may also be connected by two connection parts 110, so that the overall rigidity of the electrical connector 100 is increased. According to one or more embodiments, the connection part 110 is connected to the bodies 102 in an integrally formed manner. Each connection part 110 may be provided with at least one fusible part 111, the fusible part 111 having a smaller cross section than the stem 108 (this difference is not shown in the figures). Alternatively, each of, or one of, the connection parts 110 may also be provided with a locally narrow part (not shown in the figures), this part having a smaller cross section than any part of the body 102, including the stem 108, in order to form a fuse for cutting off an excessively high current. Advantageously, at least one locally narrow part may be formed in the connection part 110 by a hole-opening process step, for use as a fuse for cutting off an excessively high current. In addition, multiple connection parts 110 may extend along substantially Z-shaped paths, and connect multiple bodies 102 in a staggered arrangement, to match the way in which multiple battery units are arranged.

FIGS. 4a-7 show an electrical connector 200 according to one or more embodiments of the present invention. Similarly, the electrical connector 200 comprises multiple bodies 202; each can at least be divided into a first body part 202a and a second body part 202b. Specifically, the electrical connector 200 has five bodies 202 arranged in parallel, each body 202 being connected to terminals of two battery units. The first body part 202a of each body 202 extends in a plane, and is provided with a circuit connection part 203 for connecting to an operating circuit of the battery pack. The circuit connection part 203 may be integrally formed with the first body part 202a, and the circuit connection part 203 may be electrically connected by welding to a port (not shown in the figures) on a circuit board having the operating circuit. The other part of the body 202 is the second body part 202b, which is electrically connected to the first body part 202. The first body part 202a and second body part 202b are connected in an integrally formed manner. According to one or more embodiments, the electrical connector 200 is made of an elastically deformable electrically conductive material.

The second body part 202b of each body 202 is configured to be electrically connected to an end of a battery unit. As shown in FIGS. 4a-4c, the second body part 202b has at least one terminal connection part 204 for connecting to a battery unit terminal. The second body part 202b may have two terminal connection parts 204; the terminal connection part 204 is provided by the corresponding second body part 202b, and used for connecting to the corresponding terminal of a battery unit adjacent to said battery unit. The shape of the connection part 204 substantially corresponds to the shape of the terminal of the battery unit, e.g. circular as shown in the figures. The area of the terminal connection part 204 should be smaller than that of the terminal of the battery unit.

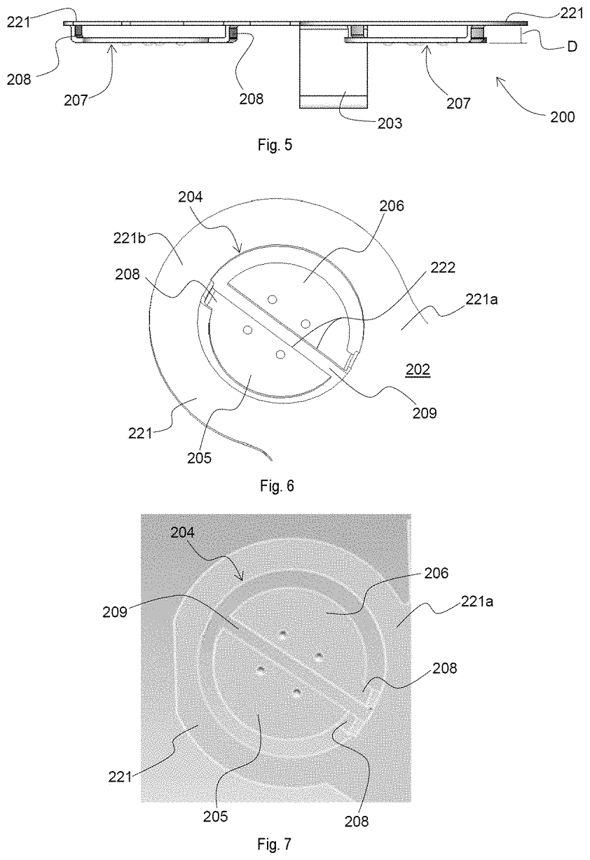

Each terminal connection part 204 has a first connection component 205 and a second connection component 206 which are at least two in number. The first connection component 205 and second connection component 206 are arranged individually. The second connection component 206 is located in substantially the same plane as the first connection component 205. The first connection component 205 and second connection component 206 are in the form of semicircles facing each other, and are configured to adjoin a surface of the terminal of the battery unit, or to be biased towards the surface of the terminal 20 of the battery unit. The first connection component 205 and second connection component 206 may be offset towards the terminal of the battery unit in relation to the second body part 202b, as shown in FIG. 5, in order to connect the terminal connection part 204 to the terminal of the battery unit.

Each connection component 205, 206 comprises a contact part 207 for contacting the terminal 20 of the battery unit, and a stem 208 connecting the contact part 207 to the remainder of the body 202. The stem 208 is the only connection path connecting each connection component 205, 206 to the second body part 202b. Specifically, the stem 208 has a smaller cross section than the contact part 207. According to FIG. 6, the stem 208 is narrower than the first and second connection components 205, 206; for example, the stem 208 is only about ⅕ of the width of the connection component. The contact parts 207 of the first and second connection components 205, 206 extend in different directions relative to each other, such that the respective stems 208 of the first and second connection components 205, 206 are at positions remote from one another on the terminal connection part 204. The angles at which the contact parts 207 of the first connection component 205 and second connection component 206 extend in different directions relative to each other differ by approximately 180°. That is to say, the contact parts 207 of the first connection component 205 and second connection component 206 extend in opposite directions relative to each other. In this way, the stems 208 of the first connection component 205 and second connection component 206 are located at maximally spaced-apart positions. The respective contact parts 207 of the first and second connection components 205, 206 are connected by the stems 208 to the remainder of the body 202 via a strip 221. The strip 221 has an outwardly projecting first end 221a connected to the remainder of the body 202, and the strip 221 has a second end 221b as a far end, which is connected to the stem 208. Alternatively, as shown in FIG. 7, the contact parts 207 of the first connection component 205 and second connection component 206 may extend in the same or substantially the same direction. However, the respective stems 208 of the first and second connection components 205, 206 are spaced apart by at least a certain distance and form a gap 209.

According to FIG. 5, surfaces of the respective contact parts 207 of the first and second connection components 205, 206 may be offset by a distance D, about 2 mm-3 mm, relative to a surface of the remainder of the body 202, such that a surface of the contact part 207 abuts a surface of the terminal of the battery unit, to facilitate welding. In addition, the strip 221 extends along an approximately circular or approximately semicircular path, and a cross section of the strip 221 is configured to be larger than a cross section of the stem 208. The respective contact parts 207 of the first and second connection components 205, 206 are arranged adjacent to each other, and the contact parts 207 of the first connection component 205 and the second connection component 206 are spaced apart by a narrow gap 209, e.g. 2-3 mm.

The contact parts 207 of the first connection component 205 and second connection component 206 are in the form of semicircles facing each other, and have respective straight edges 222; the two straight edges 222 define the abovementioned gap 209, and extend together in parallel on two opposite sides of the gap 209. The gap 209 causes the contact part 207 of the first connection component 205 to be substantially independent of the contact part 207 of the second connection component 206, and the contact parts 207 of the first connection component 205 and second connection component 206 have shapes that are substantially mirror images or reversed mirror images of each other. Alternatively, the angle at which the contact parts 207 of the first connection component 205 and the second connection component 206 extend in different directions relative to each other may be 90°-270°, i.e. at least 90° clockwise or anticlockwise. Alternatively, the angle at which the contact parts 207 of the first connection component 205 and the second connection component 206 extend in different directions relative to each other may also be reduced to the range of 170°-190°. Advantageously, the positions of the respective stems 208 of the first connection component 205 and the second connection component 206 are radially opposite each other, as shown in FIG. 6.

The contact parts 207 of the first connection component 205 and the second connection component 206 may be configured to have a substantially circular or disk-like combined shape. If it is desired to form the abovementioned shape, a process step of forming a through-hole 225 of a specific shape in the second body part 202b will generally be required. Alternatively, the contact parts 207 of the first connection component 205 and the second connection component 206 may be connected to the second body part 202a or remainder via the stems 208 directly, thus avoiding the process step of forming the through-hole 225 and saving the material forming the strip 221.

Similarly to one or more of the above embodiments, multiple bodies 202 are connected to each other by at least one connection part 210. Specifically, as shown in FIG. 4, one body 202 is connected to another body 202 of the electrical connector 200 by two connection parts 210. According to one or more embodiments, the connection parts 210 are integrally formed with the bodies 202. Each connection part 210 is provided with at least one fusible part 211, the fusible part 211 having a smaller cross section than the stem 208. Each of, or one of, the connection parts 210 may be provided with a locally narrow part 212. Similarly, the locally narrow part 212 has a smaller cross section than any part of the body 202, including the stem 208, in order to form a fuse for cutting off an excessively high current. Advantageously, a circular through-hole 213 may be provided in the connection part 210 as shown in FIG. 4a, or an elongated through-hole 213 may be provided in the connection part 210 as shown in FIG. 4b, to form at least two locally narrow parts 212, for use as a fuse for cutting off an excessively high current. FIG. 4c shows that each connection part 210 may be configured as a single narrow part, which similarly can be used as a fuse for cutting off an excessively high current. In addition, multiple connection parts 210 may extend along substantially Z-shaped paths, and connect multiple bodies 202 in a staggered arrangement, to match the way in which multiple battery units are arranged.

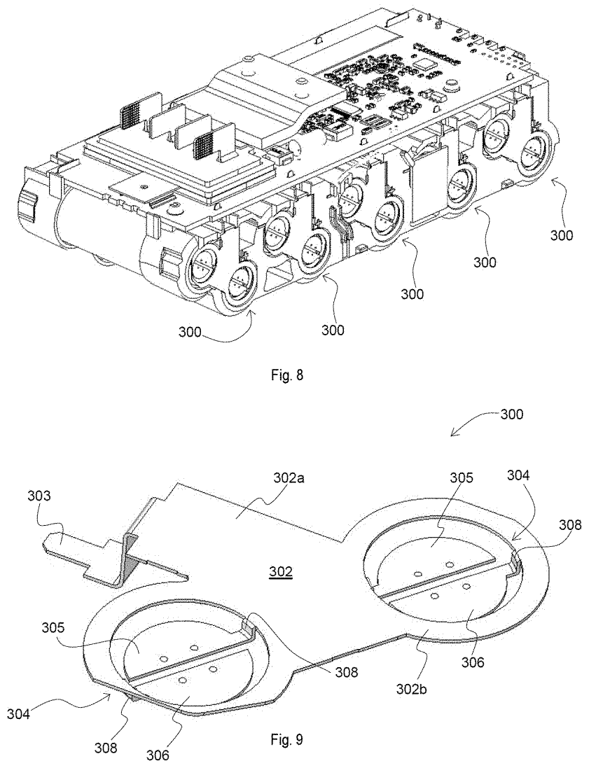

FIGS. 8 and 9 show an electrical connector 300 according to one or more embodiments of the present invention. As shown, each electrical connector 300 simultaneously connects two battery units in a specific arrangement. This embodiment is different in that the electrical connector 1 has a single body 302. Similarly, the body 302 can at least be divided into a first body part 302a and a second body part 302b. The first body part 302a is substantially flat, and the body 302 is provided with a circuit connection part 303 for connecting to an operating circuit of the battery pack. The circuit connection part 303 may be integrally formed with the first body part 302a of the body 302, but may also be connected to the first body part 302a by welding. The circuit connection part 303 is electrically connected by welding to a port (not shown in the figures) on a circuit board having the operating circuit. The other part of the body 302 is the second body part 302b, which is electrically connected to the first body part 302. The first body part 302a and second body part 302b are integrally formed. The electrical connector 300 is made of an elastically deformable electrically conductive material. The electrical connector 300 has only one body 302, the body 302 being connected to terminals of two battery units.

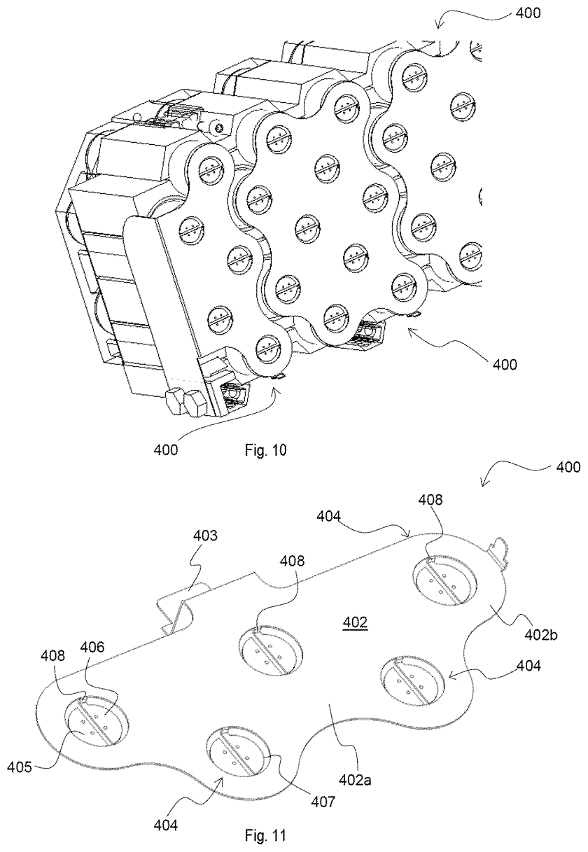

FIGS. 10 and 11 show another electrical connector 400; a body 402 thereof is simultaneously connected to terminals of as many as ten battery units. The entire battery pack may have multiple electrical connector 400, and there may be no connection between one body 402 and another body 402, so there is no connection part.

The electrical connector 300, 400 described above each comprise the body 302, 402 made of an electrically conductive material, the body having a first body part 302a, 402a and a second body part 302b, 402b, and the first body part 302a, 402a being provided with a circuit connection part 303, 403 for connecting to the operating circuit of the battery pack. The electrical connector 300, 400 also have at least one terminal connection part 304, 404 provided by the second body part 302b, 402b, for connecting to the terminal of the battery unit. The terminal connection part 304, 404 has a first connection component 305, 405 and a second connection component 306, 406 which are spaced apart and at least two in number.

Each of the connection components comprises a contact part 307, 407 for contacting the terminal of the battery unit, and the terminal connection part 304, 404 also has a stem 308, 408 connecting the contact part 307, 407 to the first body part 302a, 402a, each stem 308, 408 having a smaller cross section than the contact part 307, 407 thereof or any other part, so that the stem 308, 408 is used as a fuse for cutting off an excessively high current. The remaining features of the first connection components 305, 405, the second connection components 306, 406, the contact parts 307, 407 and the stems 308, 408 have already been described in detail above, so are not described again here.

According to the process step of assembling the battery pack to which one or more embodiments of the present invention relates, when the electrical connector is connected to a battery unit, spot welding will generally be used to weld the first connection component 305, 405 and the second connection component 306, 406 to an end of the battery unit. According to one or more embodiments, to facilitate the electric welding process, welding depressions are provided at specific positions on the surfaces of the first connection component 305, 405 and the second connection component 306, 406, e.g. at positions close to the middle, in order to guide a welding tool to the specific positions to perform spot welding.

In the process of spot welding, the welding current first flows from the welding head through the respective contact parts 307, 407 of the first connection component 305, 405 and second connection component 306, 406, and then flows through the stems 308, 408 towards the second body part 302, 402. The stems 308, 408 are the only paths leading to the second body part 302, 402, and the stems 308, 408 have a smaller cross section than the contact parts 307, 407; consequently, when the current passes through the stems 308, 408, a higher temperature will be generated than at other positions.

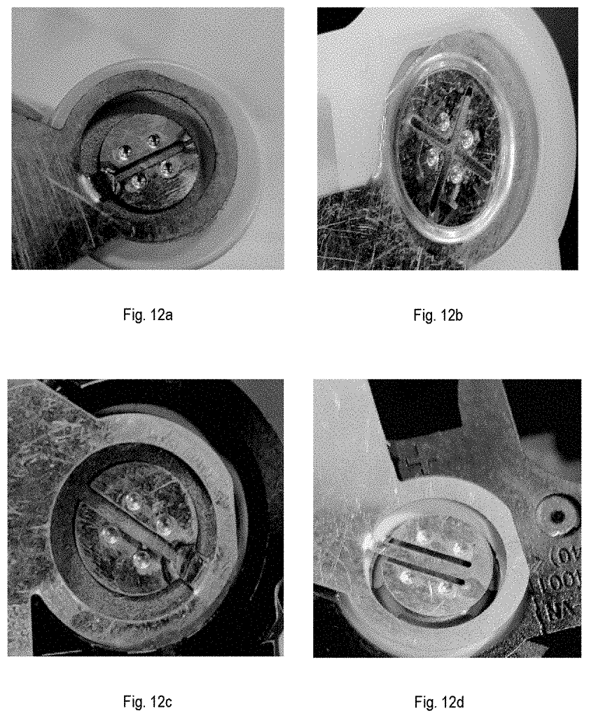

As shown in FIGS. 12a-12d, generally, when an existing electrical connector is welded by spot welding to a terminal of a battery unit, the high-voltage current generates a high temperature when passing through a position equivalent to a stem, or might cause blackening or even melt-through at the stem or the periphery thereof. In the electrical connector 300, 400 described above, the positions of the stems 308, 408 are configured to be remote from one another, and the two connection components can effectively disperse current and thermal energy, thus avoiding passage of current through the same position; this can reduce situations in which current flow is overly concentrated at the same position, thereby mitigating the problem of blackening or even melt-through at the stem or the periphery thereof.

As stated above, an electrical connector according to one or more embodiments of the present invention for connecting terminals of battery units in a battery pack provides an improvement compared with an existing electrical connection apparatus, reducing the chance that a high temperature will arise when current passes through a particular position, especially a position used as a fuse, during welding, thus effectively reducing blackening or even melt-through at the stem (i.e. the part used as a fuse) or the periphery thereof.

Those skilled in the art will understand that various changes and/or amendments may be made to the present invention shown in the particular embodiments, without departing from the spirit or scope of the present invention as broadly described. Thus, the embodiments described in the present invention should be regarded as illustrative and non-limiting in all respects.

1. An electrical connector configured to connect terminals of battery units in a battery pack, comprising:
a plurality of bodies made of an electrically conductive material, each of the bodies comprising at least a first body part and a second body part; and
at least one terminal connection part disposed adjacent the first body part configured to connect to the terminal of the battery unit,
wherein the at least one terminal connection part comprises at least one connection component,
wherein each of the at least one connection component comprises a contact part for contacting the terminal of the battery unit,
wherein each of the at least one terminal connection part further comprises at least one stem connecting the contact part to the first body part,
wherein the plurality of bodies are connected to each other by at least one connection part,
wherein each of the at least one connection part has at least one fusible part,
wherein the at least one fusible part has a smaller cross section than the at least one stem, and
wherein the at least one fusible part is operable as a fuse configured to cut off an excessively high current.

2. The electrical connector according to claim 1, wherein the at least one terminal connection part comprises a first connection component and a second connection component which are spaced apart from each other and which are each connected to one of the plurality of bodies via the at least one stem.

3. The electrical connector according to claim 1, wherein the at least one connection part is provided with a locally narrow part as the at least one fusible part.

4. The electrical connector according to claim 1, wherein an opening is provided in the at least one connection part to form the at least one fusible part.

5. The electrical connector according to claim 4, wherein the opening is a through-hole.

6. The electrical connector according to claim 1, wherein the connection part extends along a substantially Z-shaped path, and connects the plurality of bodies in a staggered arrangement.

7. An electrical connector configured to connect terminals of battery units in a battery pack, comprising:
a body made of an electrically conductive material, the body comprising at least a first body part and a second body part; and
at least one terminal connection part disposed adjacent the first body part configured to connect to the terminal of the battery unit,
wherein the at least one terminal connection part comprises a first connection component and a second connection component spaced apart from each other,
wherein each of the first and second connection components comprises a contact part for contacting the terminal of the battery unit, and a stem connecting the contact part to the body,
wherein the stem has a smaller cross section than the contact part, and
wherein the stem is operable as a fuse configured to cut off an excessively high current.

8. The electrical connector according to claim 7, wherein the contact part of the first connection component and the contact part of the second connection component extend in the same direction, or extend in different directions relative to each other.

9. The electrical connector according to claim 7, wherein the contact part of the first connection component is connected to the body by the stem via a strip.

10. The electrical connector according to claim 9, wherein the strip has an outwardly projecting first end connected to the body, and the strip has a second end as a far end, which is connected to the stem.

11. The electrical connector according to claim 10, wherein the strip extends along a partly circular or substantially semicircular path.

12. The electrical connector according to claim 7, wherein the contact part of the first connection component is arranged adjacent to the contact part of the second connection component.

13. The electrical connector according to claim 12, wherein the contact part of the first connection component and the contact part of the second connection component have respective straight edges, which extend together in parallel on two opposite sides of a gap.

14. The electrical connector according to claim 7, wherein the contact part of the first connection component and the contact part of the second connection component have shapes that are substantially mirror images of each other.

15. The electrical connector according to claim 7, wherein the contact part of the first connection component and the contact part of the second connection component are configured to form a substantially circular or disk-like combined shape.

16. The electrical connector according to claim 7, wherein the angle at which the contact part of the first connection component and the contact part of the second connection component extend in different directions relative to each other is in a range of 90°-270°.

17. The electrical connector according to claim 16, wherein the angle at which the contact parts of the first connection component and the second connection component extend in different directions relative to each other is in the range of 170°-190°.

18. The electrical connector according to claim 17, wherein the angles at which the contact parts of the first connection component and the second connection component extend in different directions relative to each other differ by 180°.

19. The electrical connector according to claim 7, wherein the respective positions of the stem of the first connection component and the stem of the second connection component are radially opposite each other.

20. (canceled)

21. The electrical connector according to claim 7, further comprising a circuit connection part disposed adjacent the first body part or the second body part, configured to connect to an operating circuit of the battery pack.
